(19) United States
(12) Patent Application Publication
(10) Pub. No.: US 2024/0293827 A1
(43) Pub. Date: Sep. 5, 2024

(54) Device for capturing and removing particles

(71) Applicant: CALEFFI S.p.A, Fontaneto d’Agogna (Navara) (IT)

(72) Inventor: Marco CALEFFI, Fontaneto d’Agogna (IT)

(21) Appl. No.: 18/575,439

(22) PCT Filed: Jun. 30, 2021
(86) PCT No.: PCT/IB2021/055863

§ 371 Date: Dec. 29, 2023

(51) Int. Cl. B03C 1/30; B01D 29/35; B01D 29/64; B01D 35/16; B03C 1/033; B03C 1/28; F28F 19/01

(52) U.S. Cl. CPC B03C 1/30; B01D 29/35; B01D 29/6415; B01D 35/16; B03C 1/0332; B03C 1/284; B03C 1/286; F28F 19/01; B03C 2201/18

(57) ABSTRACT

A device for capturing and removing dirt particles provides a main body provided with an inlet, an outlet and a main chamber obtained inside the main body in a path of a heat transfer fluid between the inlet and the outlet; inside the main chamber, in the path of the heat transfer fluid between the inlet and outlet, a dirt particles intercepting and separating element, one or more magnets for magnetically retaining ferromagnetic dirt particles, and a mesh filter for mechanically retaining dirt particles are provided in series; movable brushes rotatable from outside and intended to remove the dirt particles mechanically retained by the mesh filter are further provided inside the main chamber. It is therefore produced a small, adaptable and easy-to-clean device, with no need to remove it from the system or to open it for cleaning it.

### BACKGROUND OF THE INVENTION

The present invention relates to a device for capturing and removing particles. In particular, a device for capturing and removing particles to be inserted in domestic or industrial heating/conditioning systems in order to avoid an irregular or non-efficient operation of the system itself.

### STATE OF THE ART

Devices for capturing and removing particles are typically introduced in heating/conditioning systems inside which a heat transfer fluid circulates, in order to limit deposits of these particles in several points of the system resulting in an irregular and non-efficient operation thereof. In particular, an excessive presence of such particles may have several adverse effects on the system operation, for instance related to an irregular valve operation, a lower yield of the emission systems, deposits in supply lines, blocks or seizures within pumps, magnetite accumulating inside magnetic rotors and a lower yield of heat exchangers.

Heat transfer fluids with a high cleaning degree are also required due to energy-related issues. Attempts are being made, in fact, to implement increasingly efficient heating/conditioning systems which make it possible to use smaller amounts of heat transfer fluid in order to consume a smaller amount of thermal energy. For this purpose, systems have been installed which provide using tubes and valves having increasingly smaller size, requiring a heat transfer fluid sufficiently free from dirt particles to avoid the aforesaid adverse effects on the system operation.

The size and nature of the aforesaid suspended particles in the heat transfer fluid circulating in the system may be of several types. For example, in the heat transfer fluid there may be suspended mud particles, sand or ferrous residues with a size ranging from fractions of a millimetre to fractions of a centimetre.

To roughly remove the dirt particles, it is possible to use a dirt separator, exploiting the principle of decantation. Thereby, abruptly slowing down, at a certain point of the circuit, the heat transfer fluid circulating in the system, the dirt particles fall downwards by gravity in a quiet zone, and are then removed through a suitable discharge opening. Efficiency in removing particles depends, in this case, on the extent the heat transfer fluid is slowed down if compared to the standard speed of the fluid moving inside the system.

The removal of the dirt particles may also be obtained by intercepting them with fine mesh filters. Thereby, the removal of the particles would be highly efficient, as mesh filters would intercept all the particles having a size greater than the size of the holes on the mesh (e.g., a few hundred microns). However, removing particles by simple filtration would be rather complex to be implemented as mesh filters would get obstructed very quickly and frequent maintenance would be necessary to keep them clean and to enable the system to work efficiently and optimally.

In the heat transfer fluid, very small particles of ferromagnetic material are also suspended, in the order of some microns. These ferromagnetic residues would not be removed by simply exploiting the decantation principle, nor would be trapped by mesh filters. Despite their small dimensions, however, in the summer period when the heating system is off, these particles settle in the tubes forming layers of ferromagnetic residual material. When the heating system is turned on again, the accumulated layers of ferromagnetic residual material detach in macroscopic pieces, contributing to the irregular system operation. In order to remove these ferromagnetic material particles, a magnetic attraction must thus be exploited. The different nature and size of the particles require, then, different filtering steps, in order to greatly reduce the concentration of such particles in the heat transfer fluid circulating inside the system.

There exist on the market devices for capturing and removing particles which provide the three aforesaid particles capturing steps depending on their size and nature. The devices available on the market, however, have some drawbacks:
complex and bulky structures;
difficulty in adapting the device position depending on whether the heating/conditioning system have tubes arranged horizontally or vertically;
difficulty in carrying out cleaning and maintenance phases of the device;
need to close the heating/conditioning system and completely dismount the device in order to remove the trapped particles, increasing the system downtime;
filtering systems characterised by very low flow rate coefficients Kv and high load losses when the filter is dirty.

### OBJECT OF THE INVENTION

The object of the present invention is to overcome the above-mentioned drawbacks of the devices for capturing and removing dirt particles in heating/conditioning systems.

### BRIEF DESCRIPTION OF THE INVENTION

Such an object is reached by a device for capturing and removing dirt particles according to the first claim.

### BRIEF DESCRIPTION OF THE DRAWINGS

To better understand the invention, an exemplary, non-limiting embodiment thereof is hereinafter described, shown in the accompanying drawings wherein:

FIG. 1 is a side section view of a device for capturing and removing dirt particles according to the invention;

FIG. 2 is a top section view of the device of FIG. 1;

FIG. 3 is an exploded perspective view of the device of FIG. 1;

FIGS. 4,5 are side section views of the device of FIG. 1;

FIG. 6 is a top section view of the main body of the device of FIG. 1;

FIGS. 7A, 7B show two front views of two components of FIG. 1;

FIG. 8 is a side view of the device of FIG. 1 with an extracted component;

FIGS. 9A, 9B are respectively a side view of the device of FIG. 1 and a top view of a component of the device of FIG. 1;

FIG. 10 is a partial section view from above of the device of FIG. 1;

FIG. 11 is a partial section view of the device of FIG. 1;

FIGS. 12A-12H are full views of the device of FIG. 1.

### DETAILED DESCRIPTION OF THE INVENTION

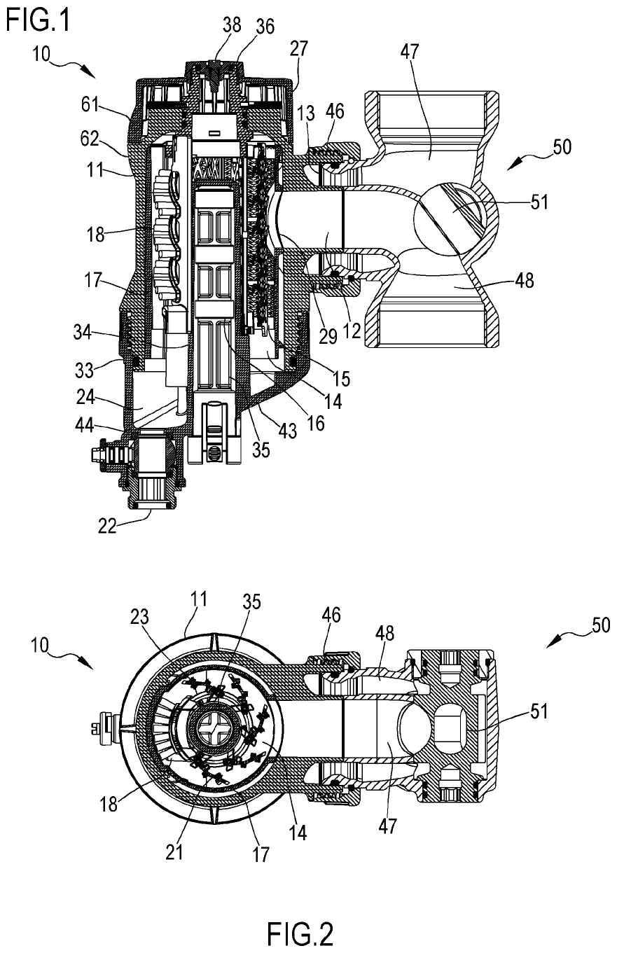

The device for capturing and removing dirt particles shown in FIG. 1, referred to as a whole by 10, is suitable to be installed in tubes connected to a heating/conditioning system in which a heat transfer fluid circulates.

The device 10 allows to capture dirt particles suspended in the heat transfer fluid circulating inside the system, and further allows to remove them from the device through a suitable discharge valve placed at a lower part of the device. Such particles may be of different nature and dimension and, if not removed, may settle at different points of the system causing an irregular or non-efficient operation of the system itself.

The device 10 includes a main body 11, which can have a cylindrical shape. An inlet 12 and an outlet 13, respectively for the entry and exit of the heat transfer fluid circulating in the system to which the device 10 is connected, are obtained on the main body 11. The inlet 12 and the outlet 13 are made circular-shaped on a side wall of the cylindrically shaped main body 11. More particularly, the inlet 12 has a circular section and the outlet 13 has an annular section, being the inlet 12 and the outlet 13 made coaxially.

Inside the main body 11 a main chamber 14 is obtained, which main chamber defines a path of the heat transfer fluid between the inlet 12 and the outlet 13.

At a lower end 30a, the main body 11 has a thread 32 for screwing a lower body 33 which sealingly closes at the bottom the main body 11. Between the main body 11 and the lower body 33, internally, it is obtained a collection chamber 24 which is intended to collect the dirt particles captured by means of the device 10. Said collection chamber 24 is provided below the main chamber 14.

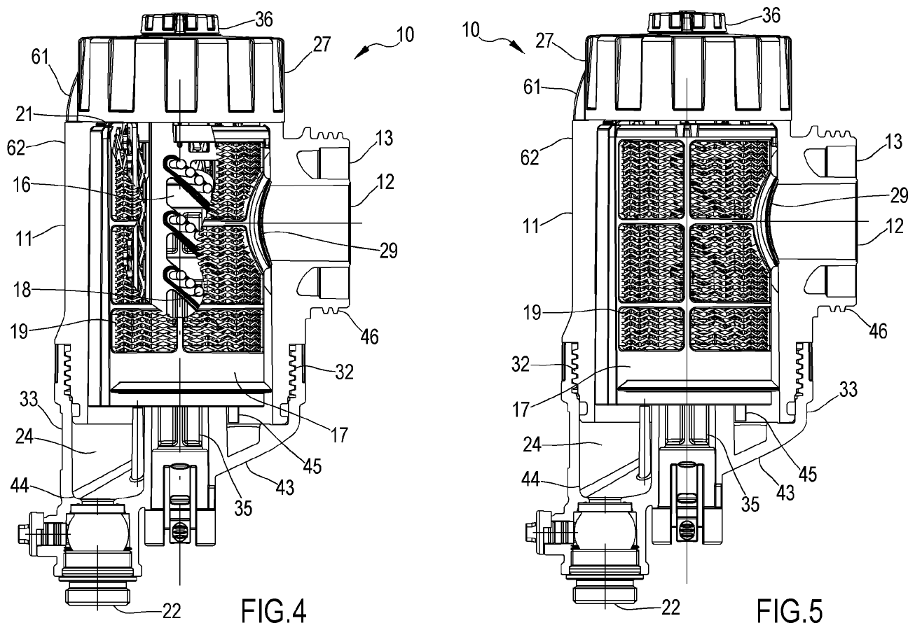

The lower body 33 has a bottom surface 43 which is tilted relative to the horizontal direction. The collection chamber 24 consequently has a triangle section, approximately a right-angled triangle-shaped section, which can be better seen in FIGS. 4,5. The section of the bottom surface 43 approximately identifies the hypotenuse of the right-angled triangle.

On the bottom surface 43 of the lower body 33 a discharge valve 22 is provided, which discharge valve can be manually opened for removing the dirt particles suspended in the heat transfer fluid and captured by the device 10. The discharge valve 22 is, in particular, obtained on a lower edge 44 of the lower body 33.

The lower body 33 has a central protrusion 34 obtained on the bottom surface 43. The central protrusion 34 protrudes centrally along the axis of the cylindrically shaped main body 11, inside the main chamber 14. The central protrusion 34 is made as hollow and open at the bottom, and it is intended to house, therein, a support rod 35. Said support rod 35 is for supporting a series of magnets 16, in this specific case three magnets 16, intended to magnetically attract ferromagnetic dirt particles suspended in the heat transfer fluid circulating in the system which the device 10 is connected to. In particular, the magnets 16 create a magnetic field in the surrounding area, more precisely inside the main chamber 14 in which the heat transfer fluid circulates; the ferromagnetic particles suspended in the heat transfer fluid are affected by the magnetic field and settle in the outer wall of the central protrusion 34.

The magnets 16 supported by the support rod 35 are shaped as a ring.

Depending on the operative requirements, the support rod 35 may be inserted into, or extracted from, a lower opening of the central protrusion 34, as it will be clear from the hereinafter description.

The device 10 also provides, inside the main chamber 14, an intercepting and separating element 15 for the dirt particles suspended in the heat transfer fluid.

The intercepting and separating element 15 includes a plurality of net-like walls 21 having an approximately rectangular shape snap-fitted to a circular section main body 23 of the intercepting and separating element 15.

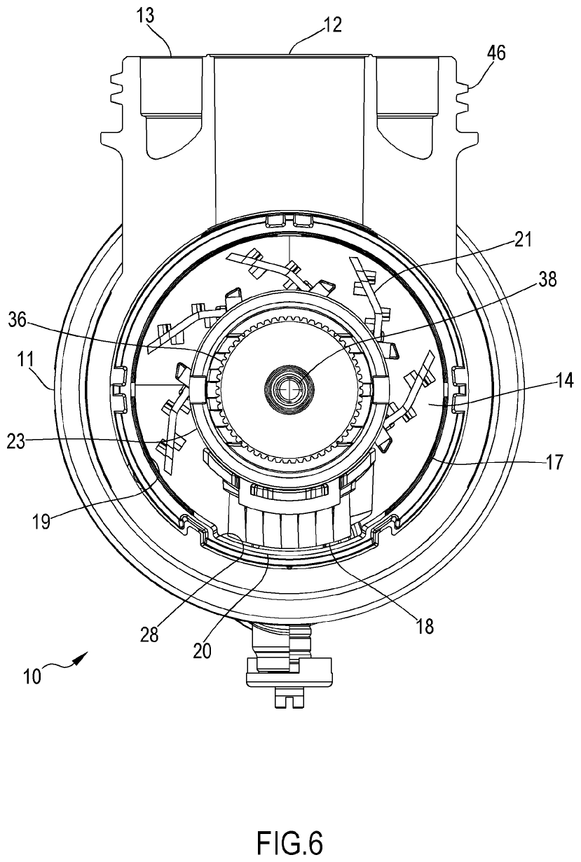

The net-like walls 21 are snap-fitted to said central body 23 through a longer side of said rectangle. In particular, as visible from the section view of FIG. 2 or FIG. 6, in each snap-fitting point the net-like walls 21 are directed according to a direction substantially tangent to the circular section central body 23.

The plurality of net-like walls 21 is intended to intercept and separate the dirt particles present in the heat transfer fluid circulating in the system by decantation.

The central body 23 of the intercepting and separating element 15 is hollow and is fitted on the central protrusion 34.

In the upper part of the central body 23 of the intercepting and separating element 15 a second thread 41, an annular groove 42 and a system of circumferential teeth 52 are obtained.

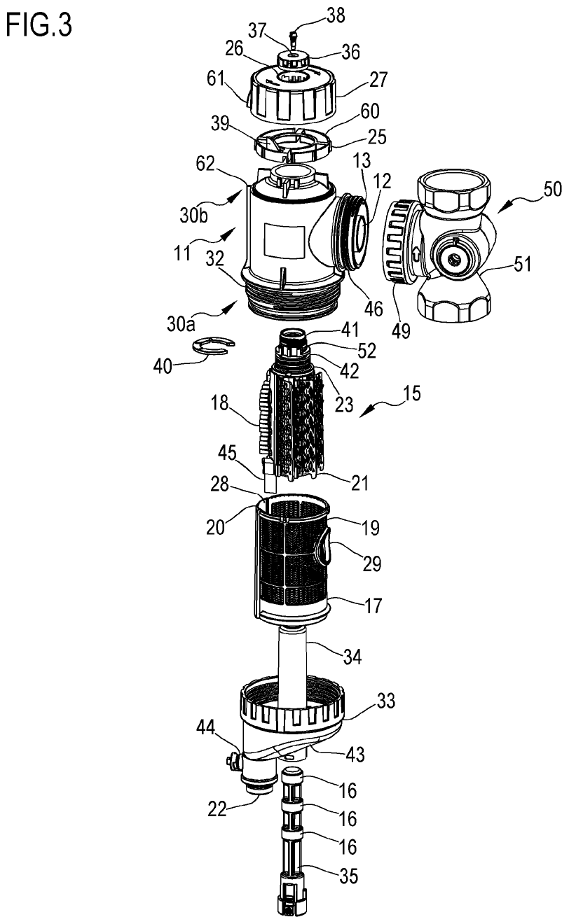

A locking clip 40, visible in FIG. 3, is provided to lock the intercepting and separating element 15 to the main body 11 of the device 10. The locking clip 40 has an open ring shape and has a plurality of cross cuts to ease inserting the locking clip 40 into the annular groove 42 in order to lock the intercepting and separating element 15 to the main body 11, making it possible in any case for the intercepting and separating element 15 to rotate about its own axis.

A mesh filter 17 is also inserted inside the main chamber 14 of the main body 11 of the device 10. The mesh filter 17 has a load-bearing structure made of cylindrically shaped rigid plastic material. On the load-bearing structure of the mesh filter 17 an inlet hole 29 is obtained for the heat transfer fluid entering the main chamber 14. The inlet hole 29 of the mesh filter 17 is circular and is arranged at the inlet 12 of the main body 11. More particularly, the diameter of the inlet hole 29 of the mesh filter 17 is substantially the same as the diameter of the inlet 12 of the main body 11.

The mesh filter 17 provides for a plurality of net portions 19 intended to mechanically retain the dirt particles present in the heat transfer fluid circulating in the system, and a hole-free continuous portion 20.

The net portions 19 of the mesh filter 17 are provided with very small holes, such as in the order of a hundred of micron. Considering for example a mesh filter 17 with net portions 19 provided with 150-micron-holes, the mesh filter 17 is able to capture particles greater than 150 micron. More precisely, particles smaller than 150 micron but comparable to this value, such as of the same order of magnitude, have a high likelihood to intercept the weft of the net portions 19 of the mesh filter 17, remaining trapped and reducing the real size of the single hole. Therefore, as time goes by, the likelihood that the mesh filter 17 is able to also intercept smaller particles than the size of the holes increases, according to the present example smaller than 150 micron.

The mesh filter 17, the intercepting and separating element 15 and the central protrusion 34 containing the series of magnets 16 have a cylindrical symmetry and are arranged inside the main chamber 14 coaxially from the outermost to the innermost in the order they are mentioned in this paragraph.

The intercepting and separating element 15, the magnets 16 and the mesh filter 17 are arranged in series in the path of the heat transfer fluid between the inlet 12 and the outlet 13 inside the main body 11 of the device 10.

The device 10 further provides, inside the main body 11, movable brushes 18 intended to remove the dirt particles mechanically retained by the mesh filter 17.

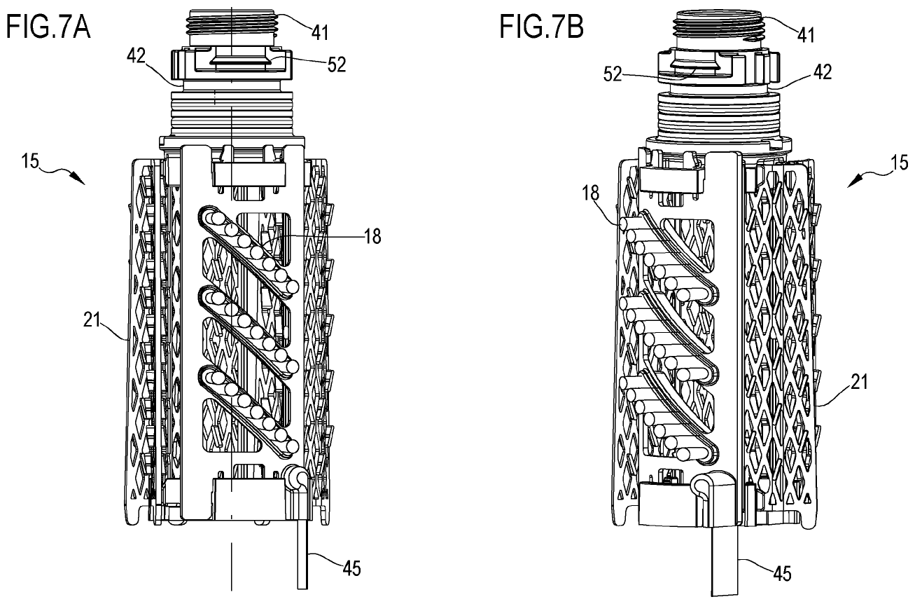

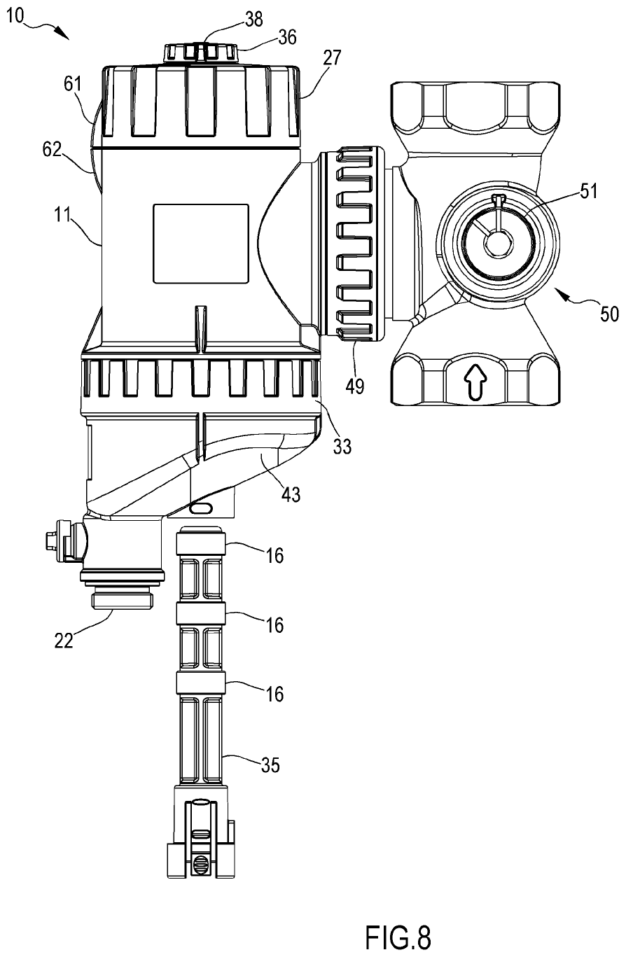

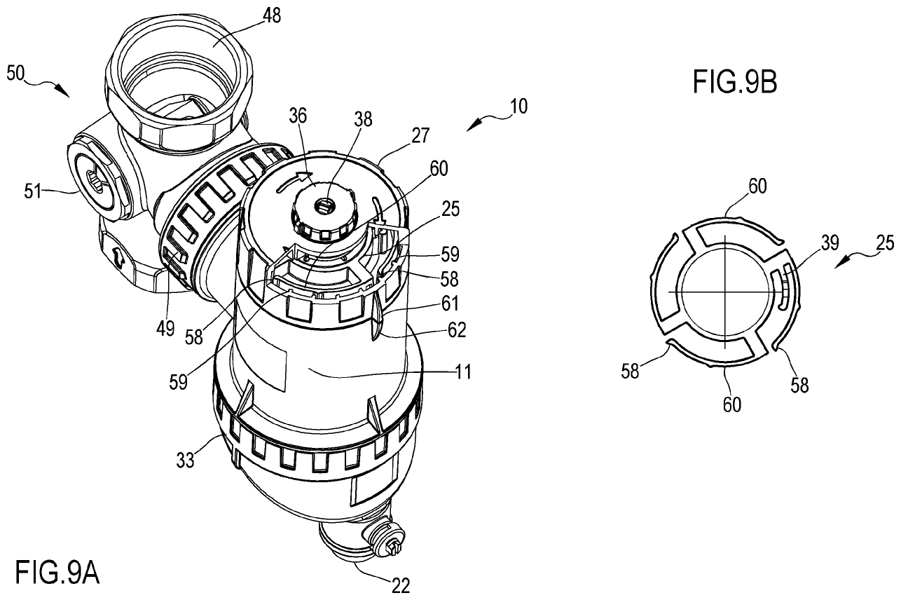

The movable brushes 18, in particular, may be actuated from outside to allow the dirt particles mechanically retained by the mesh filter 17 to fall by gravity into the collection chamber 24. More precisely, the movable brushes 18 may be rotated from outside. As shown in FIGS. 7A, 7B, the movable brushes 18 are tilted to allow the dirt particles mechanically retained by the mesh filter 17 to fall by gravity into the collection chamber only if rotated clockwise. For example, the movable brushes 18 may be tilted by 45° with respect to the horizontal direction, with such an orientation as to drag the dirt particles downwards.

The movable brushes are arranged in a portion of the intercepting and separating element 15 between two net-like walls 21.

The rotation of the movable brushes 18 from outside occurs by means of a knob 27, arranged above the main body 11 of the device 10. In particular, the knob 27 rotates integrally with the intercepting and separating element 15 on which the movable brushes 18 are arranged.

The intercepting and separating element 15 is in fact hooked to the aforesaid knob 27 through the system of circumferential teeth 52.

A spatula 45 protrudes below the movable brushes 18. Such spatula 45 is a lamella of harmonic steel which can be rotated from outside integrally with the movable brushes 18 by means of the knob 27. When rotated clockwise, the spatula 45 is intended to scratch on the bottom of the collection chamber 24 to convey the particles accumulated on the bottom of the aforesaid collection chamber 24 towards the discharge valve 22.

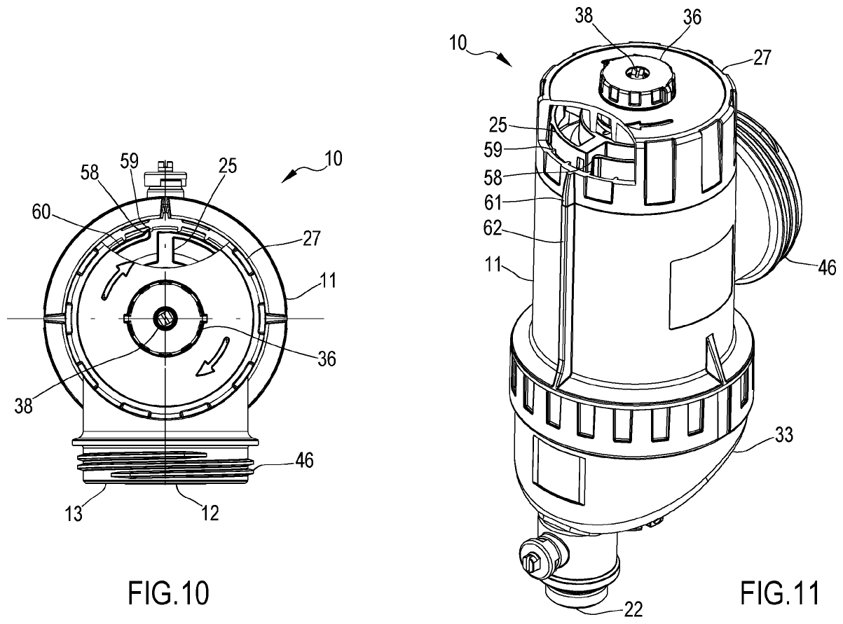

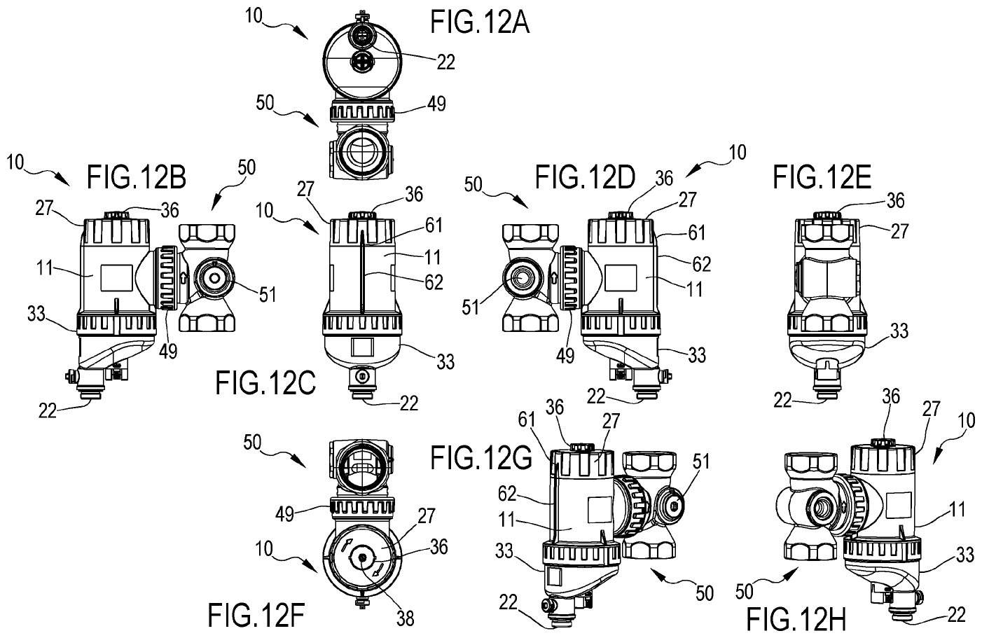

The knob 27 can be rotated only clockwise to allow the dirt particles mechanically retained by the mesh filter 17 to fall by gravity into the collection chamber 24. As shown in FIGS. 10,11, in the knob 27 there may be arrows indicating to the user the rotation direction of the knob itself.

The knob 27 has inner ribs 59.

A cam 25 is interposed between the knob 27 and the main body 11 of the device 10. More precisely, the cam 25 is snap-fitted on an upper end 30b of the main body 11. The cam 25 has a fin 39 protruding vertically above the cam 25 and defining a rest position of the movable brushes 18. The cam 25 has also four circumferential fins 60, each circumferential fin 60 having a free end 58 shaped to contact each of the inner ribs 59 of the knob 27. In particular, the contact between each free end 58 and each inner rib 59 is such to enable a clockwise rotation of the knob 27, and to prevent a counter-clockwise rotation of the knob 27, i.e., in the rotation direction opposite to the one that enabling the dirt particles retained by the mesh filter 17 to fall by gravity into the collection chamber 24.

Furthermore, the knob 27 has a first outer rib 61. The main body 11 has a second outer fin 62.

The knob 27 has a first central hole 26 intended to house a plug 36, which plug 36 may be removed if additives need to be added to the heat transfer fluid circulating in the system. The central hole 26 may be, for instance a circular hole. The plug 36 is screwed to the central body 23 of the intercepting and separating element 15 by the second thread 41.

The plug 36 has in turn a second central hole 37 which is closed with an air relief screw 38.

The screw 38 may be removed if air needs to be evacuated from the main body 11 of the device 10.

As described above and as visible in particular in FIG. 3 and FIG. 6, the mesh filter 17 has a continuous portion 20. At such continuous portion 20, the mesh filter 17 has at least one recess 28 for housing the movable brushes 18 when these brushes are not used for removing the dirt particles mechanically retained by the mesh filter 17.

The mesh filter 17 is shaped, then, such that the movable brushes contact the net portions 19 when the movable brushes are actuated in clockwise rotation from outside for removing the dirt particles retained by the aforesaid mesh filter 17. The mesh filter 17 is also shaped such that the movable brushes do not contact the continuous portion 20 at the recess 28.

The position of the movable brushes 18 at the recess 28, previously referred to as the rest position of the movable brushes 18, can be further recognised from outside as corresponding to the configuration wherein the position of the first outer rib 61 matches the position of the second outer rib 62. Consequently, the first outer rib 61 and the second outer rib 62 indicate to the user the rest position of the movable brushes 18 if the ribs 61 and 62 are aligned.

Alternatively, when the first outer rib 61 and the second outer rib 62 are not aligned, they allow the user to understand that the movable brushes 18 are in contact with the net portions 19 of the mesh filter 17 to allow removing the dirt particles mechanically retained by the mesh filter 17.

The size of the device 10 differs according to the flow rate of the heat transfer fluid supported by the system. In particular, if the flow rate is low, the size of the device 10 will be smaller; vice versa, if the flow rate is higher the size of the device 10 will be greater.

The device 10 is connected, upstream of the inlet 12 and downstream of the outlet 13, to a T-shaped element 50. The element 50 is intended to convey the heat transfer fluid from the system into the inlet 12 of the device 10 for the dirt particles capturing and removing operations. At the same time, the element 50 is intended to convey the heat transfer fluid from the outlet 13 of the device 10 into the system after the dirt particle capturing and removing operations.

The device 10 is provided with a third thread 46 for connecting sealingly with the element 50 by the connection end 49.

As it can be seen in FIG. 1, the element 50 has an inlet channel 47 which allows the heat transfer fluid to enter the device 10 through the inlet 12. The element 50 further has an outlet channel 48 which allows the heat transfer fluid to exit the device 10 through the outlet 13.

The inlet channel 47 and the outlet channel 48 do not communicate with each other.

The section of the inlet channel 47 of the element 50 at the connection end 49 is sized such to match the inlet 12 of the device 10. The section of the outlet channel of the element 50 at the connection end 49 is sized such to match the outlet 13 of the device 10.

The element 50, as well as the device 10, is sized according to the flow rate of the heat transfer fluid supported by the system. In particular, if the flow rate is low, the size of the element 50 will be smaller; vice versa, if the flow rate is higher the size of the element 50 will be greater.

The element 50 is also intended to partialize the flow. The element 50 has, in fact a flow diverter 51. The flow diverter 51 has a cylindrical shape and can be rotated from outside.

The flow diverter 51 is shaped such to divert the flow of the heat transfer fluid into the device 10 through the inlet channel 47 of the element 50. In particular, the flow diverter 51 adjusts, based on its angular position, the flow rate of the heat transfer fluid inside the device 10, so that only a percentage of the flow rate of heat transfer fluid circulating in the system can enter the device 10. For instance, the flow diverter 51 allows the 40% of the flow rate of heat transfer fluid to enter the device 10; the flow diverter 51 also allows the remaining 60% of the flow rate of the heat transfer fluid to flow directly into the outlet channel 48, without temporarily undergoing the dirt particle capturing and removing step.

The main function of the flow diverter 51 is to obtain high flow rate coefficient values Kv and to reduce, at the same time, the consumption of energy required to allow the heat transfer fluid to circulate inside the system. For example, during the first steps of the circuit opening, all the flow rate of the heat transfer fluid is flown into the device 10, leaving the flow diverter 51 in a non-operating configuration, in order to submit all the flow rate of the heat transfer fluid to the three filtering steps. Then, in order to reduce the system energy consumption, the flow diverter 51 is set in an operating configuration such that only a part of the heat transfer fluid is submitted to the three filtering steps, for instance with the above-described percentages.

The flow diverter 51 of the element 50 may also be intended for adjusting the flow rate of the heat transfer fluid especially in case the flow rate of the heat transfer fluid circulating in the system is so high that decantation would be little effective, due to the high speed of motion of the fluid. Moreover, if the flow rate of the heat transfer fluid were too high, the mesh filter 17 would also get obstructed very rapidly, making it necessary to immediately and constantly clean it by rotating the movable brushes 18. In order to make the process of capturing and removing dirt particles inside the device 10 last longer, it is therefore necessary to reduce the flow rate of the heat transfer fluid entering the device 10, so that the heat transfer fluid is little by little submitted to the step of capturing and removing dirt particles.

Therefore, in order to have a sufficiently clean heat transfer fluid circulating inside the system to avoid the irregular operation of the above-mentioned system, it is necessary to carry out several cycles of the heat transfer fluid passing through the system, so that, after a variable number of cycles, the whole flow rate of fluid has undergone the dirt particle capturing and removing step inside the device 10.

The operation of the device 10, connected to the element 50, will be now described in detail.

The heat transfer fluid circulating in the system with a given amount of dirt particles, enters the element 50 and is conveyed, through the inlet channel 47, towards the inlet 12 of the device 10. Inside the device 10, the heat transfer fluid meets, in series, the intercepting and separating element 15, the magnets 16 and the mesh filter 17. In the order, then, the heat transfer fluid is submitted to the decantation process, causing a reduction of the fluid speed and encouraging dirt particles to fall by gravity downwards; the ferromagnetic particles suspended in the heat transfer fluid are affected by the magnetic field generated by the magnets 16, thereby such ferromagnetic particles are constrained on the wall of the central protrusion 34; the heat transfer fluid is filtered by the net portions 19 of the mesh filter 17 for removing the dirt particles having size greater than the holes of the mesh filter 17, as described above; finally the heat transfer fluid exits the outlet 13 of the device 10 and flows through the outlet channel 48 of the element 50 to be introduced again into the system with an amount of dirt particles smaller than the initial one.

The decantation-separated dirt particles settle immediately on the bottom, at the bottom surface 43 of the collection chamber 24. After some time from when the heat transfer fluid has started passing inside the device 10, a remarkable amount of ferromagnetic particles will have deposited on the wall of the central protrusion 34, and a remarkable amount of dirt particles in the net portions of the mesh filter 17.

Extracting the support rod 35 supporting the magnets 16 out of the central protrusion 34, the ferromagnetic particles deposited on the wall of the central protrusion 34 are no longer affected by the magnetic attraction that kept them constrained to the aforesaid wall, thereby they fall by gravity and also deposit on the bottom surface 43 of the collection chamber 24.

In order to remove the dirt particles mechanically retained on the net portions 19 of the mesh filter 17, the movable brushes 18 are rotated from outside by the knob 27. The above-described structural shape of the movable brushes 18 makes it possible, once they are rotated clockwise, for the dirt particles mechanically retained on the net portions 19 of the mesh filter 17 to fall by gravity and deposit on the bottom surface 43 of the collection chamber 24.

The rotation of the movable brushes 18 is further integral with the rotation of the spatula 45, which acts on the particles deposited on the bottom surface 43 of the collection chamber 24 pushing them towards the discharge valve 22.

The opening of the discharge valve 22 allows to outflow and remove the dirt particles captured by the device 10.

One advantage of the device 10 according to the invention is its compact and non-bulky structure, which makes it possible to carry out the three fluid filtering steps within the same main body.

Another advantage is that the position of the device 10 can be easily adapted to horizontally or vertically arranged tubes, by virtue of the device 10 connecting with the element 50.

A further advantage is that cleaning and maintenance steps of the device 10 can be carried out easily, in particular it is possible to remove the dirt particles without disassembling the device 10. Disassembling the device 10 for the necessary cleaning and maintenance thereof would involve inserting also shut-off valves for closing the system. This would make the system more complex and expensive, as well as it would increase downtime of the system.

In an alternative embodiment, the support rod 35 may support one only magnet 16.

In another alternative embodiment, the movable brushes 18 may have an inclination rotated by 90° if compared to the configuration shown in the enclosed figures. In this case, rotating counter-clockwise the movable brushes 18 by means of the knob 27, the removal and descent by gravity towards the collection chamber 24 of the dirt particles mechanically captured by the mesh filter 17 is equally obtained.

Configuration variants of the above-described components shown in the enclosed drawings are possible.

1. Device for capturing and removing dirt particles for tubes connected to a heating/conditioning system in which a heat transfer fluid circulates, including a main body where an inlet and an outlet are provided, a main chamber, defining a path of the heat transfer fluid between the inlet and the outlet, and a collection chamber below the main chamber being obtained inside the main body, and a dirt particles intercepting and separating element, one or more magnets for magnetically retaining ferromagnetic dirt particles, and a mesh filter for mechanically retaining dirt particles being provided in series in the path between the inlet and the outlet.

2. Device according to claim 1, wherein the intercepting and separating element, the one or more magnets and the mesh filter are arranged coaxially inside the main chamber of the main body.

3. Device according to claim 2, wherein the main body internally has movable brushes which can be actuated from outside for removing the mechanically retained dirt particles.

4. Device according to claim 3, wherein the movable brushes are tilted and may be rotated from outside to allow the dirt particles mechanically retained by the mesh filter to fall by gravity into the collection chamber.

5. Device according to claim 3, wherein the movable brushes are arranged in a portion of the intercepting and separating element.

6. Device according to claim 5, wherein the intercepting and separating element and the movable brushes are integral with a rotatable knob to allow the dirt particles mechanically retained by the mesh filter to fall by gravity into the collection chamber.

7. Device according to claim 1, wherein the intercepting and separating element includes a plurality of radially arranged net-like walls, the plurality of net-like walls being intended to intercept and separate the dirt particles by decantation.

8. Device according to claim 1, wherein the mesh filter provides an inlet hole for the flow of the heat transfer fluid into the main chamber, the inlet hole being arranged at the inlet of the main body.

9. Device according to claim 1, wherein the mesh filter provides one or more net portions for mechanically retaining the dirt particles, and a hole-free continuous portion.

10. Device according to claim 3, wherein the mesh filter provides at least a recess, at the hole-free continuous portion, for housing the movable brushes when they are not used.

11. Device for capturing and removing particles according to claim 1, wherein the one or more magnets are mounted on a removable rod arranged along the central axis of the main chamber of the main body.

12. Device for capturing and removing particles according to claim 1, wherein a discharge valve is provided below the collecting chamber, the discharge valve being openable to remove the captured particles by the intercepting and separating element, the one or more magnets and the mesh filter.

13. Device for capturing and removing particles according to claim 1, wherein a T-shaped element is provided upstream of the inlet and downstream of the outlet to convey the heat transfer fluid into the inlet such that the fluid undergoes the operations of capturing and removing the dirt particles, and to convey into the system the heat transfer fluid from the outlet after the operations of capturing and removing dirt particles.

14. Device for capturing and removing particles according to claim 13, wherein the T-shaped element includes an inlet channel for the heat transfer fluid entering the device for capturing and removing dirt particles through the inlet, and an outlet channel for the heat transfer fluid exiting the device for capturing and removing dirt particles through the outlet, said inlet and outlet channels being non-communicating with each other.

15. Device for capturing and removing particles according to claim 13, wherein the T-shaped element includes a flow diverter rotatable from outside to adjust the flow rate of the heat transfer fluid inside the device based on its angular position.
